(19) United States
(12) Patent Application Publication
(10) Pub. No.: US 2007/0244913 A1
(43) Pub. Date: Oct. 18, 2007

(54) System, method and apparatus for generating a formatted data set

(76) Inventors: Reid F. Hayhow, La Porte, CO (US); Carli Connally, Fort Collins, CO (US); Kristin N. Casterton, Fort Collins, CO (US)

Correspondence Address: VERIGY, 4700 INNOVATION WAY, BLDG D1, FORT COLLINS, CO, 80528, US

(21) Appl. No.: 11/404,545

(22) Filed: Apr. 13, 2006

(51) Int. Cl. G06F 7/00

(52) U.S. Cl. 707/101

(57) ABSTRACT

In one embodiment, a method of generating a formatted data set in accord with a number of formatting rules includes the steps of A) indexing, with a standard data name referenced by one of the formatting rules, a mapping set comprising a first number of mapping pairs, each mapping pair comprising 1) a custom data name and 2) a corresponding standard data name; B) if a custom data name corresponding to the standard data name referenced by the formatting rule is found in the mapping set, C) accessing test data associated with a tester performing tests on a number of devices under test; D) identifying a data item in the test data that is associated with the custom data name corresponding to the standard data name referenced by the formatting rule; and E) then, formatting the data item associated with the custom data name in accord with the formatting rule referencing the standard data name.

### BACKGROUND

Testers, such as the 93000 System On Chip (SOC) tester from Agilent Technologies, Inc., allow for the execution of tests which implement custom data names to report test results of a test on a device under test (DUT).

Implementing a custom data name also requires the processors of the tester's output be able to properly read the custom data names in order to correctly process the test results. Failure to maintain the processors' logic in lockstep with the tester naming convention may result in processing errors or data omissions. Processor maintenance is further complicated by processors that receive the output from two or more testers, each utilizing different custom data names.

### SUMMARY OF THE INVENTION

In one embodiment, a method of generating a formatted data set in accord with a number of formatting rules includes the steps of A) indexing, with a standard data name referenced by one of the formatting rules, a mapping set comprising a first number of mapping pairs, each mapping pair comprising 1) a custom data name and 2) a corresponding standard data name; B) if a custom data name corresponding to the standard data name referenced by the formatting rule is found in the mapping set, C) accessing test data associated with a tester performing tests on a number of devices under test; D) identifying a data item in the test data that is associated with the custom data name corresponding to the standard data name referenced by the formatting rule; and E) then, formatting the data item associated with the custom data name in accord with the formatting rule referencing the standard data name.

In another embodiment, a method of generating a formatted data set in accord with a number of formatting rules includes the steps of A) accessing test data associated with a tester performing tests on a number of devices under test, the test data comprising a number of data items, at least one of which is associated with a custom data name; B) accessing a mapping set comprising a first number of mapping pairs, each mapping pair comprising 1) a custom data name and 2) a corresponding standard data name; C) substituting, in the test data, the at least one custom data name with the corresponding standard data name; and D) after the substitutions, generating the formatted data set using the test data.

In another embodiment, a system includes A) a processor; and B) a number of formatters, each generating a formatted data set in accord with a number of formatting rules and each causing the processor to, i) index, with a standard data name referenced by one of the formatting rules, a mapping set comprising a first number of mapping pairs, each mapping pair comprising 1) a custom data name and 2) a corresponding standard data name; ii) upon a custom data name corresponding to the standard data name being found in the mapping set, iii) access test data associated with a tester performing tests on a number of devices under test; iv) identify a data item in the test data that is associated with the custom data name; and v) then, format the data item associated with the custom data name in accord with the formatting rule referencing the standard data name.

In another embodiment, a system for standardizing test data associated with a tester performing tests on a number of devices under test, the test data comprising a number of data items, at least one of which is associated with a custom data name, includes A) an interface, operable to, i) access the test data; and ii) access a mapping set comprising a number of mapping pairs, each mapping pair comprising 1) a custom data name and 2) a corresponding standard data name; and B) a processor, operable to, upon locating a custom data name in the test data corresponding to the custom data name of one of the mapping pairs, replacing the custom data name in the test data with the corresponding standard data name.

In another embodiment, one or more machine-readable mediums having stored thereon sequences of instructions, which, when executed by a machine, cause the machine to perform the actions of A) indexing, with a standard data name referenced by one of the formatting rules, a mapping set comprising a first number of mapping pairs, each mapping pair comprising 1) a custom data name and 2) a corresponding standard data name; B) if a custom data name corresponding to the standard data name referenced by the formatting rule is found in the mapping set, 1) accessing test data associated with a tester performing tests on a number of devices under test; 2) identifying a data item in the test data that is associated with the custom data name corresponding to the standard data name referenced by the formatting rule; and 3) then, formatting the data item associated with the custom data name in accord with the formatting rule referencing the standard data name.

And, in yet another embodiment, one or more machine-readable mediums having stored thereon sequences of instructions, which, when executed by a machine, cause the machine to perform the actions of A) accessing test data associated with a tester performing tests on a number of devices under test, the test data comprising a number of data items, at least one of which is associated with a custom data name; B) accessing a mapping set comprising a first number of mapping pairs, each mapping pair comprising 1) a custom data name and 2) a corresponding standard data name; and C) substituting, in the test data, the at least one custom data name with the corresponding standard data name.

Other embodiments are also disclosed.

### BRIEF DESCRIPTION OF THE DRAWINGS

Illustrative embodiments of the invention are illustrated in the drawings, in which:

FIG. 1 illustrates a first exemplary method for generating a formatted data set;

FIG. 2 illustrates a second exemplary method for generating a formatted data set;

FIG. 3 illustrates an exemplary system for generating a formatted data set; and

FIG. 4 illustrates an exemplary system for standardizing test data.

### DETAILED DESCRIPTION

As a preliminary manner, it is noted that, in the following description, like reference numbers appearing in different drawing figures refer to like elements/features. Often, therefore, like elements/features that appear in different drawing figures will not be described in detail with respect to each of the drawing figures.

Testers perform tests on devices under test (DUTs) and output test data. The test data may be individual measurements, events, or more complex structures. The test data may be generated in a format that is in conformity with a standard naming convention, such as one in compliance with the STDF (Standard Test Data Format, occasionally also known as the Standard Teradyne Data Format), XML (extensible Markup Language), HTML (HyperText Markup Language), or other target format. Test data may also be customized and be associated with, for example, custom data names. A formatter then reads the test data, applies formatting rules, and produces formatted test data. If the data produced is in conformity with one formatter, it may still appear “custom” to other formatters expecting a different format.

If test developers and operators needed to only follow one naming convention, and that one naming convention fulfilled all of their data acquisition and reporting requirements and never changed, then tests would only need to generate test data compliant with the one naming convention. However, this is counter productive in many test environments. A single naming convention would restrict changes, such as changes used to accommodate new technology, new reporting standards, systems optimization and customization, and users' changes (e.g., debugging and experimentation).

Test data is generally raw data (e.g., a series of individual measurements) and needs to be formatted to be usable by human and/or computerized test analyzers. Raw test data is generally optimized for rapid output and, therefore, may comprise a minimal amount of data and implement symbols (e.g., enumerations) in place of more verbose descriptors. By formatting test data, the minimal data output is converted to a more usable format. For example, test data may contain enumerations (e.g., “7”=Error). A formatter may then translate such enumerations into more verbose data as well as incorporate the context of the measurement (e.g., “Ground pin 14 not at chassis potential”).

Formatters read test data, apply formatting rules, and produce formatted test data compliant with either a standard format type (e.g., STDF, XML, HTML, et cetera) or custom format types (e.g., DUT-specific, company, lab, engineer, and/or ad hoc). A formatter may be programmed to read test data that is compliant with one or more format types, however, programming and maintaining each formatter to read the various format types, or format type versions, is burdensome and error prone.

The ability to produce test data with custom data names allows greater flexibility in producing test data. By equating custom data names to standard data names, the formatters need only be able to process standard data names and thereby reduce maintenance and potential errors.

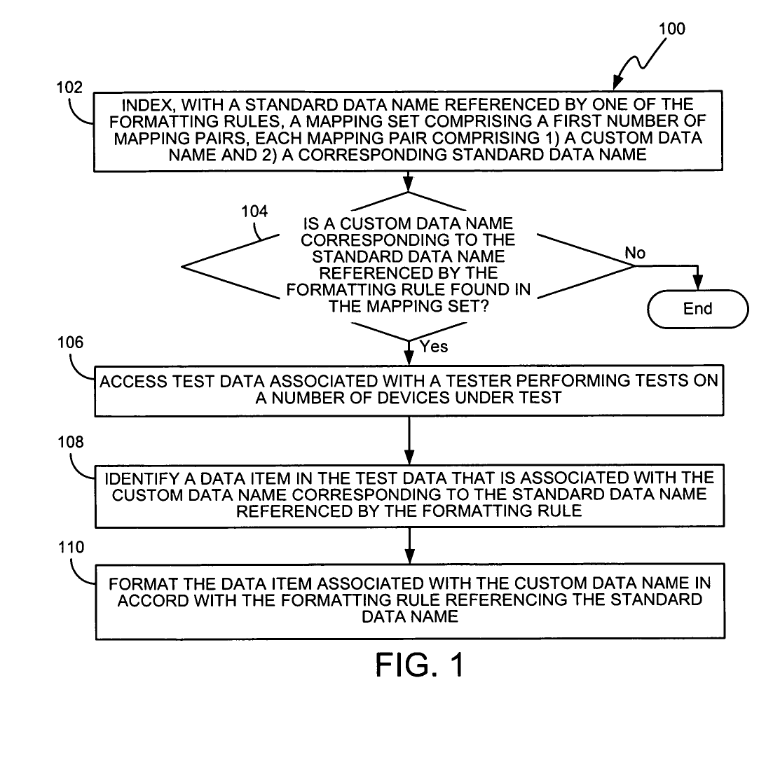

FIG. 1 illustrates first exemplary method 100 for generating a formatted data set. Method 100 comprises steps 102, 104, 106, 108, 110. Step 102 indexes, with a standard data name referenced by one of the formatting rules, a mapping set comprising a first number of mapping pairs, each mapping pair comprising 1) a custom data name and 2) a corresponding standard data name. Step 104 determines if a custom data name corresponding to the standard data name referenced by the formatting rule is found in the mapping set and, if so, executes steps 106, 108, and 110. Step 106 accesses test data associated with a tester performing tests on a number of devices under test. Step 108 identifies a data item in the test data that is associated with the custom data name corresponding to the standard data name referenced by the formatting rule. Step 110 then, formats the data item associated with the custom data name in accord with the formatting rule referencing the standard data name.

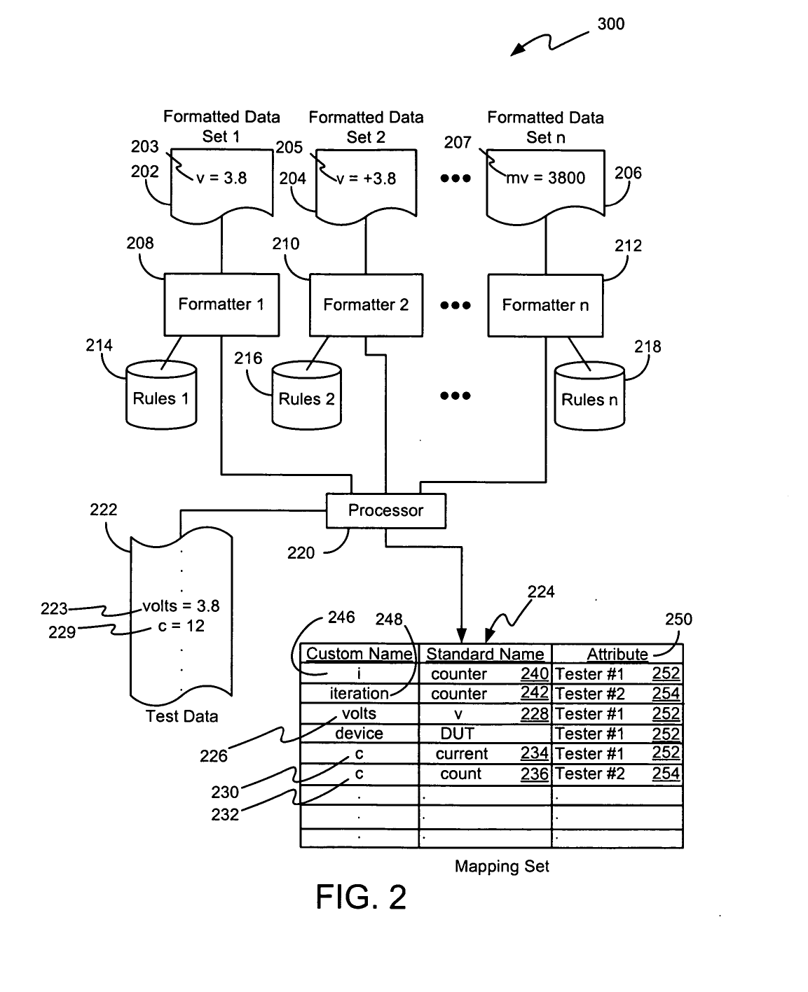

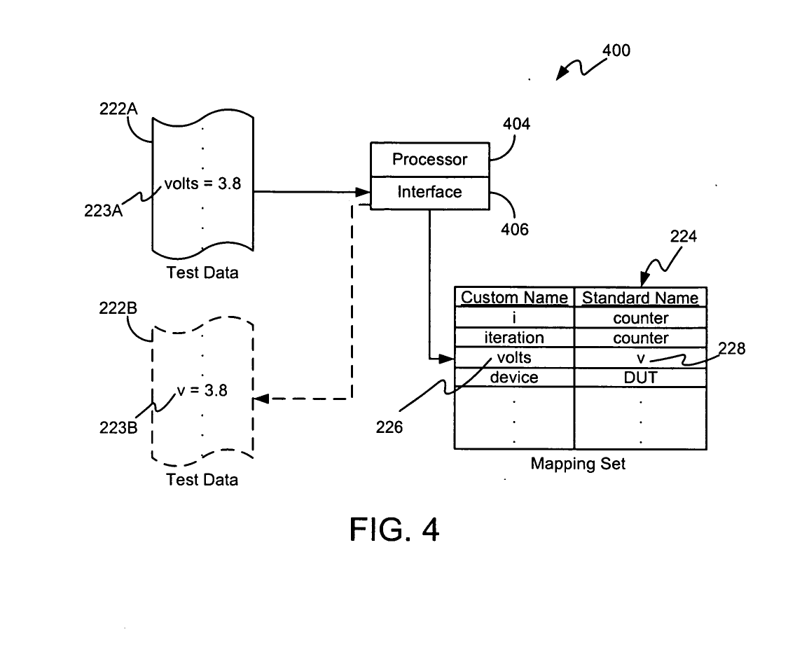

Mapping sets (see, mapping set 224 in FIGS. 2 and 4) provide a translation between a custom name and a standard name. As an example, a standard name may include “volts”. However, a test may be developed that generates test data using a custom name, such as, “v”, “3”, “millivolts”, “mv” or other name as a representation for “volts”. A formatter, or other test data processor reading the test data without the ability to utilize a mapping set, either has to be programmed to correctly process the custom name or else portions of the test data may be omitted or processed erroneously.

Programming of the formatters with each potential custom name results in populating the formatters with a cumbersome collection of formatting instructions, many of which will have a limited lifespan but remain in the formatter. Programming is further complicated when a formatter is utilized to format test data generated with different custom names. Programming a formatter to map the custom name “3” for volts, for example, results in erroneous results if the formatter is then used to format data that uses the custom name “3” as milliampere. Programmatically accounting for similar custom names adds to the clutter of the formatter's logic. However, providing a formatter with a mapping set, prior to accessing test data containing custom data names mapped by the mapping set, allows the test data to be correctly associated with a standard name without reprogramming the formatter.

In one embodiment, indexing 102 further comprises indexing a second number of mapping pairs. In a further embodiment, if one of the first number of mapping pairs comprises a standard data name equivalent to the standard data name of one of the second number of mapping pairs, priority is given to the one of the second number of mapping pairs. By implementing such an embodiment, many potential conflicts are resolved. For example, a test may be programmed to produce an output consistent with a company naming convention, that is, in association with a first number of mapping pairs (e.g., custom name is “c” and the standard name is “current”). A user wanting to implement a change causes the test data to be customized a second time, such as by utilizing a second number of mapping pairs (e.g., the custom name is “c” and the standard name is “count”). Selecting the second mapping pair (e.g., instances of “c” are formatted according to the rules for “count”) resolves the conflict.

In another embodiment, at least one mapping pair is created in response to a user's input. In a further embodiment, an interface (e.g., graphical user interface) receives the user's input and, in yet another further embodiment, the interface presents custom data names and/or standard data names to aide the user's selection. In a still further embodiment, the test data is parsed by a program in order to derive custom data names for presentation to the user.

FIG. 2 illustrates exemplary system 200 for generating formatted data sets (202, 204, 206). Test data 222 contains at least one data item 223 associated with a custom name 226 corresponding to a standard name 228 referenced by a formatting rule. Formatters 1, 2, n (208, 210, 212) access formatting rules 214, 216, 218, and produce formatted data sets 1, 2, n (202, 204, 206), each respectively. Formatter 1 (208) causes processor 220 to index mapping set 224 with standard data names, such as standard data name 228 (“v”), in accord with formatting rules 214. For example, rules 214 may utilize a standard name (“v”) to indicate a voltage. Rules 214 may then instruct formatter 1 (308) to populate formatted data set 202 with a formatted data item 203. Rule 214 may, for example, create formatted data item 203 in the form of <the standard name><equals sign><value to the tenths place>. As another example, rules 216 may utilize the standard name 228 “v” to populate formatted data set 204 with formatted data item 205, in the format <standard name><equals sign><positive or negative sign><value to the tenths place>. As another example, rules 218 may create formatted data item 207 in the form of <“mv”><equals sign><value×1000>. In other embodiments, formatting rules combine one or more values from test data 223 with data and/or logic from additional sources to produce the content of formatted data sets 1, 2, n (208, 210, 212).

After indexing mapping set 224 with the standard data name 228, and upon custom data name 226 corresponding to standard data name 228 being found in mapping set 224, processor 220 accesses test data 222. Test data 222 may be the direct, buffered, and/or stored output of one or more tester performing tests on a number of DUTs. Processor 220 identifies data item 223 in test data 222 as being associated with custom data name 226. Processor 220 then formats data item 223 in accord with the formatting rules 214, 216, 218 referencing standard data name 228.

In one embodiment, rules 214 are stored on magnetic and/or optical media. In other embodiments, rules 214 are in stored in memory and/or microcode. In further embodiments, rules 214 are distinct from the formatters 1, 2, n (208, 210, 212), as illustrated, or integrated into the logic of formatters 1, 2, n (208, 210, 212). In other embodiments, formatters 1, 2, n, (208, 210, 212) may be distinct from processor 220, as illustrated, or may be integrated into or executed by processor 220. Furthermore, processor 220 may be one or more processing components, devices and/or systems.

In another embodiment, mapping set 224 comprises at least two mapping pairs having equivalent custom data names 230, 232 and different standard data names 234, 236. At least two formatters 1, 2, n (208, 210, 212) cause processor 220 to index different ones of the at least two mapping pairs, via their different standard data names 234, 236. Data item 229, associated with the equivalent custom names 230, 232, is then formatted in accord with the respective formatting rules 214, 216, 218 of the at least two data formatters 208, 210, 212 referencing the respective standard data name 234, 236 of the different ones of the at least two mapping pairs.

As an example, test data 222 contains data item 229. Data item 229 is to be formatted in accord with one mapping pair but a conflict exists as two equivalent custom names 230, 232 (“c”) are within mapping set 224. Formatter 1 (202) formats with standard name 234 (“current”) and formatter 2 (204) formats with standard name 236 (“count”), as determined by formatting rules 1, 2 (214, 216), respectively.

In another embodiment, two or more formatters 1, 2, n (202, 204, 206), for example, formatter 1 (202) and formatter 2 (204), cause processor 220 to index mapping pairs with equivalent standard name 240, 242 (“counter”), each with different custom names 246, 248 (“i”,“iteration”). Based on an attribute, such as attribute 250, formatter 1 (202) selects custom name 246 (“i”) in accord with attribute value 252 (“Tester #1”) and formatter 2 (204) selects custom name 248 (“iteration”) in accord with attribute value 254 (“Tester #2”). Attribute 250 is variously embodied and, in addition to indicators of origination, may include priority, target formatter, time/date, purpose, and/or an identifier associated with a superset of the mapping pairs (e.g., file name, database table name), wherein equivalent standard name 240, 242 are each located in different superset of mapping pairs. Attribute 250 may be integrated with mapping set 224 or determined from attributes or calculations external to mapping set 224.

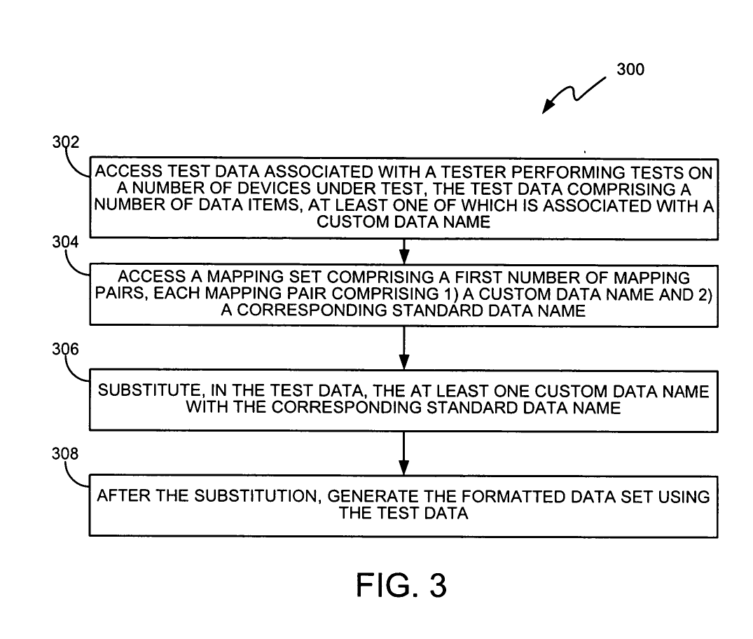

FIG. 3 illustrates second exemplary method 300 for generating a formatted data set, comprising steps 302, 304, 306, 308. Step 302 accesses test data associated with a tester performing tests on a number of devices under test, the test data comprising a number of data items, at least one of which is associated with a custom data name. Step 304 accesses a mapping set comprising a first number of mapping pairs, each mapping pair comprising 1) a custom data name and 2) a corresponding standard data name. Step 306 substitutes, in the test data, the at least one custom data name with the corresponding standard data name. Step 308, after the substitutions, generates the formatted data set using the test data.

In one embodiment, accessing 304 further comprises accessing a second number of mapping pairs. In a further embodiment, if one of the first number of mapping pairs comprises a standard data name equivalent to the standard data name of one of the second number of mapping pairs, giving priority to the one of the second number of mapping pairs. By implementing such an embodiment, conflicts are resolved by giving priority to the second number of mapping pairs.

In another embodiment, at least one mapping pair is created in response to a user's input. In a further embodiment, an interface receives the user's input and, in yet another further embodiment, the interface presents custom data names and/or standard data names to aide the user's selection. In a still further embodiment, the test data is parsed in order to derive custom data names for presentation to the user.

FIG. 4 illustrates exemplary system 400 for standardizing test data 222A. Interface 406 accesses test data 222A and mapping set 224. Mapping set 224 of FIG. 4 omits attribute 250 for clarity. Mapping set 224 contains mapping pairs, such as the mapping pair comprising custom name 226 and standard name 228. Processor 400, upon locating custom data name 223A in test data 222A, replaces the custom data name 223A (e.g., “volts”) with standard name 228 (e.g., “v”). Custom data name 223A then becomes custom data name 223B and, as a result, test data 222A becomes test data 222B.

What is claimed is:

1. A method of generating a formatted data set in accord with a number of formatting rules, comprising:
indexing, with a standard data name referenced by one of the formatting rules, a mapping set comprising a first number of mapping pairs, each mapping pair comprising 1) a custom data name and 2) a corresponding standard data name;
if a custom data name corresponding to the standard data name referenced by the formatting rule is found in the mapping set,
accessing test data associated with a tester performing tests on a number of devices under test;
identifying a data item in the test data that is associated with the custom data name corresponding to the standard data name referenced by the formatting rule; and
then, formatting the data item associated with the custom data name in accord with the formatting rule referencing the standard data name.

2. The method of claim 1, wherein:
indexing the mapping set further comprises indexing a second number of mapping pairs; and
if one of the first number of mapping pairs comprises a standard data name equivalent to the standard data name of one of the second number of mapping pairs, giving priority to the one of the second number of mapping pairs.

3. The method of claim 1, further comprising, in response to a user's input, creating at least one of the mapping pairs.

4. The method of claim 3, further comprising:
parsing the test data; and
presenting a number of data names in the test data to the user for selection as a custom data name of the created mapping pair.

5. A method of generating a formatted data set in accord with a number of formatting rules, comprising:
accessing test data associated with a tester performing tests on a number of devices under test, the test data comprising a number of data items, at least one of which is associated with a custom data name;
accessing a mapping set comprising a first number of mapping pairs, each mapping pair comprising 1) a custom data name and 2) a corresponding standard data name;
substituting, in the test data, the at least one custom data name with the corresponding standard data name; and
after the substitutions, generating the formatted data set using the test data.

6. The method of claim 5, wherein:
accessing the mapping set further comprises accessing a second number of mapping pairs; and
if one of the first number of mapping pairs comprises a standard data name equivalent to the standard data name of one of the second number of mapping pairs, giving priority to the one of the second number of mapping pairs.

7. The method of claim 5, further comprising, in response to a user's input, creating at least one of the mapping pairs.

8. The method of claim 7, further comprising:
parsing the test data; and
presenting a number of custom data names in the test data to the user for selection as a custom data name of the created mapping pair.

9. A system, comprising:
a processor; and
a number of formatters, each generating a formatted data set in accord with a number of formatting rules and each causing the processor to,
index, with a standard data name referenced by one of the formatting rules, a mapping set comprising a first number of mapping pairs, each mapping pair comprising 1) a custom data name and 2) a corresponding standard data name;
upon a custom data name corresponding to the standard data name being found in the mapping set,
access test data associated with a tester performing tests on a number of devices under test;
identify a data item in the test data that is associated with the custom data name; and
then, format the data item associated with the custom data name in accord with the formatting rule referencing the standard data name.

10. The system of claim 9, wherein:
the mapping set further comprises at least two mapping pairs having equivalent custom data names and different standard data names; and
at least two of the number of formatters are further operable to cause the processor to,
index different ones of the at least two mapping pairs , via their different standard data names; and
format a data item associated with the equivalent custom data names, in accord with respective formatting rules of the at least two data formatters referencing the respective standard data name of a different one of the at least two mapping pairs.

11. The system of claim 9, wherein:
the mapping set further comprises at least two mapping pairs with equivalent standard data names and different custom data names; and
at least two of the number of formatters are further operable to cause the processor to,
index different ones of the at least two mapping pairs with equivalent standard data names, based on attributes of ones of the at least two mapping pairs; and
format a data item associated with the equivalent standard data name in accord with respective formatting rules of the at least two data formatters referencing the respective custom data name and mapping pair attribute of the at least two mapping pairs.

12. The system of claim 9, further comprising, an interface, operable to create at least one of the mapping pairs, in response to a user's input.

13. A system for standardizing test data associated with a tester performing tests on a number of devices under test, the test data comprising a number of data items, at least one of which is associated with a custom data name, comprising:
an interface, operable to,
access the test data; and
access a mapping set comprising a number of mapping pairs,
each mapping pair comprising 1) a custom data name and 2) a corresponding standard data name; and
a processor in communication with the interface, operable to, upon locating a custom data name in the test data corresponding to the custom data name of one of the mapping pairs, replacing the custom data name in the test data with the corresponding standard data name.

14. The system of claim 13, further comprising, a user interface, operable to create at least of the one mapping pairs, in response to a user's input.

15. One or more machine-readable mediums having stored thereon sequences of instructions, which, when executed by a machine, cause the machine to perform the actions of:
indexing, with a standard data name referenced by one of the formatting rules, a mapping set comprising a first number of mapping pairs, each mapping pair comprising 1) a custom data name and 2) a corresponding standard data name;
if a custom data name corresponding to the standard data name referenced by the formatting rule is found in the mapping set,
accessing test data associated with a tester performing tests on a number of devices under test;
identifying a data item in the test data that is associated with the custom data name corresponding to the standard data name referenced by the formatting rule; and
then, formatting the data item associated with the custom data name in accord with the formatting rule referencing the standard data name.

16. The machine-readable mediums of claim 15, wherein:
the instructions for indexing the mapping set further comprise instructions for indexing a second number of mapping pairs; and
the instructions further comprise instructions for, if one of the first number of mapping pairs comprise a standard data name equivalent to the standard data name of one of the second number of mapping pairs, giving priority to the one of the second number of mapping pairs.

17. The machine-readable mediums of claim 15, further comprising instructions for, in response to a user's input, creating at least one of the mapping pairs.

18. The machine-readable mediums of claim 17, further comprising instructions for:
parsing the test data; and
presenting a number of data names in the test data to the user for selection as a custom data name of the created mapping pair.

19. One or more machine-readable mediums having stored thereon sequences of instructions, which, when executed by a machine, cause the machine to perform the actions of:
accessing test data associated with a tester performing tests on a number of devices under test, the test data comprising a number of data items, at least one of which is associated with a custom data name;
accessing a mapping set comprising a first number of mapping pairs, each mapping pair comprising 1) a custom data name and 2) a corresponding standard data name; and
substituting, in the test data, the at least one custom data name with the corresponding standard data name.

20. The machine-readable mediums of claim 19, wherein:
the instructions for accessing the mapping set further comprise instructions for accessing a second number of mapping pairs; and
the instructions further comprise instructions for, if one of the first number of mapping pairs comprises a standard data name equivalent to the standard data name of one of the second number of mapping pairs, giving priority to the one of the second number of mapping pairs.

21. The machine-readable mediums of claim 20, further comprising instructions for:
parsing the test data; and
presenting a number of custom data names in the test data to the user for selection as a custom data name of the created mapping pair.
